(19) United States
(12) Patent Application Publication
(10) Pub. No.: US 2006/0040176 A1
(43) Pub. Date: Feb. 23, 2006

(54) Prismatic battery cells, batteries with prismatic battery cells and methods of making same

(76) Inventors: Pui Tsang Peter Ling, Hong Kong (CN); Sung On Andrew Ng, Hong Kong (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/975,995

(22) Filed: Oct. 29, 2004

(30) Foreign Application Priority Data
Nov. 3, 2003 (CN) 03107923.4

(51) Int. Cl. H01M 2/24; H01M 2/26

(52) U.S. Cl. 429/160; 429/161

(57) ABSTRACT

A prismatic battery cell including a positive electrode group and a negative electrode group which are connected respectively to a positive current collector and a negative current collector, each said positive electrode group and said negative electrode group respectively including a plurality of positive and negative electrode plates, said positive and negative electrode groups are assembled so that positive and negative electrode plates are alternately stacked with separators interposed between adjacent positive and negative electrodes, wherein the electrode plates of an electrode group being bundled together and welded to the corresponding current collector, the welding being generally along the bundled portion of the electrode group and at least on the surface of said current collector away from said electrode group.

### FIELD OF THE INVENTION

This invention relates to prismatic battery cells, batteries with prismatic battery cells and methods of making same. More particularly, this invention relates to rechargeable prismatic battery cells and rechargeable batteries with prismatic battery cells. More specifically, although of course not solely limited thereto, this invention relates to rechargeable NiMH rechargeable batteries with prismatic cells.

### BACKGROUND OF THE INVENTION

Battery cells with a general prismatic shape are commonly and loosely referred and known as prismatic battery cells. Prismatic battery cells have a characteristic prismatic shape, more specifically, a rectangular prismatic shape, because the battery cell is typically constructed from a plurality of substantially rectangular electrode plates which are parallelly stacked and stacked to form a substantially rectangular prismatic electrode group. Each of the parallel electrode plates are connected to their respective current collectors which are in turn connected to their respective contact terminals.

The sub-assembly of the electrode groups, the current collectors and the contact terminals are typically packaged in a prismatic housing so that the packaged battery cell has an overall prismatic shape and hence the calling “prismatic battery cells”. A prismatic battery typically comprises a plurality of prismatic battery cells arranged in parallel and integrally bound so that the battery also has an overall prismatic shape. However, it should be appreciated that the term “prismatic battery cell” generally refers to battery cells having a plurality of parallelly stacked electrode plates which are electrically connected together along their corresponding lateral sides, as distinguished to a cylindrical battery cell in which each electrode group comprises an electrode plate which is helically or spirally coiled into a plurality of substantially cylindrical surfaces.

In this specification, the term “prismatic battery cell” does not mean to restrict or limit to battery cells of a prismatic shape but extends generally to include battery cells having positive and negative electrode groups each having a plurality of parallelly stacked electrode plates which are connected together on one side and non-electrically connected on the other, opposite, side. The electrode plates of the positive and the negative electrode groups are alternately stacked with respect to each other and extend through the openings of the corresponding electrode group before connecting to the corresponding current collector. It will be appreciated that while it is common for prismatic battery cells to have rectangular electrode plates, it is neither essential nor strictly necessary that the electrode plates are rectangular.

Batteries with prismatic cells are commonly used in high current applications or in applications in which a high power density is required. For example, rechargeable prismatic batteries such as Nickel Metal Hydride (NiMH) batteries have been widely used as power sources in electrical vehicles (EV) or hydride electrical vehicles (HEV) in recent years because of their superior energy density characteristics.

Typically, electrical energy is produced by chemical reaction between the positive and negative electrode groups in the presence of a liquid electrolyte and the electrical energy is delivered to the load first via the current collectors and than through the contact terminals. In many batteries, the contacts between the electrode plates and the current collectors are an important source of the internal resistance of a battery. A high internal resistance means high energy wastage as well as introducing heat dissipation problems, since heat will be generated at the junctions between the electrode plates and the current collectors. Such energy wastage and heat generation are particularly undesirable for high current applications such as electrical vehicles or hydride electrical vehicles since the efficiency is adversely affected and the internal heat needs to be properly dissipated to avoid premature failure or battery damage due to over-heating.

U.S. Pat. No. 6,544,684 describes a prismatic battery in which current collector plates are perpendicularly welded to the side edges of the electrode plates along a plurality of selected locations along the length on the inside surface of the current collector adjacent the electrode plates.

U.S. Pat. No. 6,457,667 proposes the use of thermal spray process to make connection between the electrodes and the current collectors.

However, conventional construction of prismatic battery cells is not entirely satisfactory and it is desirable to provide improved prismatic battery cells and batteries incorporating same.

### SUMMARY OF THE INVENTION

According to the present invention, there is provided a prismatic battery cell including a positive electrode group and a negative electrode group which are connected respectively to a positive current collector and a negative current collector, each said positive electrode group and said negative electrode group respectively including a plurality of positive and negative electrode plates, said positive and negative electrode groups are assembled so that positive and negative electrode plates are alternately stacked with separators interposed between adjacent positive and negative electrodes, wherein the electrode plates of an electrode group being bundled together and welded to the corresponding current collector, the welding being generally along the bundled portion of the electrode group and at least on the surface of said current collector away from said electrode group.

Preferably, said current collector including an elongated through channel in which the bundled portion of said electrode group, is received, said electrode group being welded to said current collector substantially along said channel.

Preferably, said channel extending substantially parallel to the longer side of said electrode plates.

Preferably, said through channel being near the center of said current collector.

Preferably, said channel extending longitudinally along the length of said current collector.

Preferably, the width of said current collector being comparable or larger than the stacked thickness of said electrode groups.

Preferably, said current collector including a plate-like member, the width of said plate-like member being substantially orthogonal to said electrode plates so that the welded portion has a generally T-shaped cross-section.

Preferably, the thickness of said current collector exceeds the thickness suitable for electronic beam welding or carbon dioxide laser welding.

Preferably, said welding being by arc-welding, including TIG welding.

Preferably, said battery cell being a rechargeable nickel metal battery cell with an alkaline electrolyte.

Preferably, the bundled portion of said electrode group being sandwiched between said current collector.

Preferably, said battery cell being sealed inside a plastic housing and said current collector being connected to contact terminals exposed outside said plastic housing, the width of the cross-section of said contact terminal being comparable to the width of the stacked electrode plates.

### BRIEF DESCRIPTION OF THE DRAWINGS

Preferred embodiments of the present invention will be explained in further detail below by way of examples and with reference to the accompanying drawings, in which:—

FIG. 1 shows a plurality of interposed positive and negative electrode plates parallelly stacked together,

FIG. 1A is a top plane view of the stacked electrode plates of FIG. 1,

FIG. 2 shows the stacked electrode plates of FIG. 1 bundled together into a positive electrode group and a negative electrode group,

FIG. 2A shows a top plane view of the bundled electrode groups of FIG. 2,

FIG. 3A shows a partially exploded assembly drawing of a first preferred embodiment of a sub-assembly comprising the positive and negative electrode groups, the current collector and the contact terminals,

FIG. 3B is a partial exploded view of the sub-assembly of FIG. 3A and a prismatic battery cell housing,

FIG. 4A shows a partially exploded assembly drawing of a second preferred embodiment of a sub-assembly comprising the positive and negative electrode groups, the current collector and the contact terminals,

FIG. 4B is a partial exploded view of the sub-assembly of FIG. 4A and a prismatic battery cell housing,

FIG. 5A shows a partially exploded assembly drawing of a third preferred embodiment of a sub-assembly comprising the positive and negative electrode groups, the current collector and the contact terminals,

FIG. 5B is a partial exploded view of the sub-assembly of FIG. 5A and a prismatic battery cell housing,

FIG. 6 shows a prismatic battery comprising a plurality of prismatic battery cells of the present invention.

### DETAILED DESCRIPTION OF THE PREFERRED EMBODIMENTS

In the specification below, reference is made to a Nickel-Metal-Hydride (NiMH) battery as a convenient example for illustration since Nickel-Metal-Hydride rechargeable batteries have been widely used and are known to have a superior power density characteristic, at a reasonable price and with a reasonable battery life. However, it would be appreciated by a skilled person that the principles described in the present specification apply mutantis mutandis to other types of prismatic batteries, especially rechargeable prismatic batteries, without loss of generality.

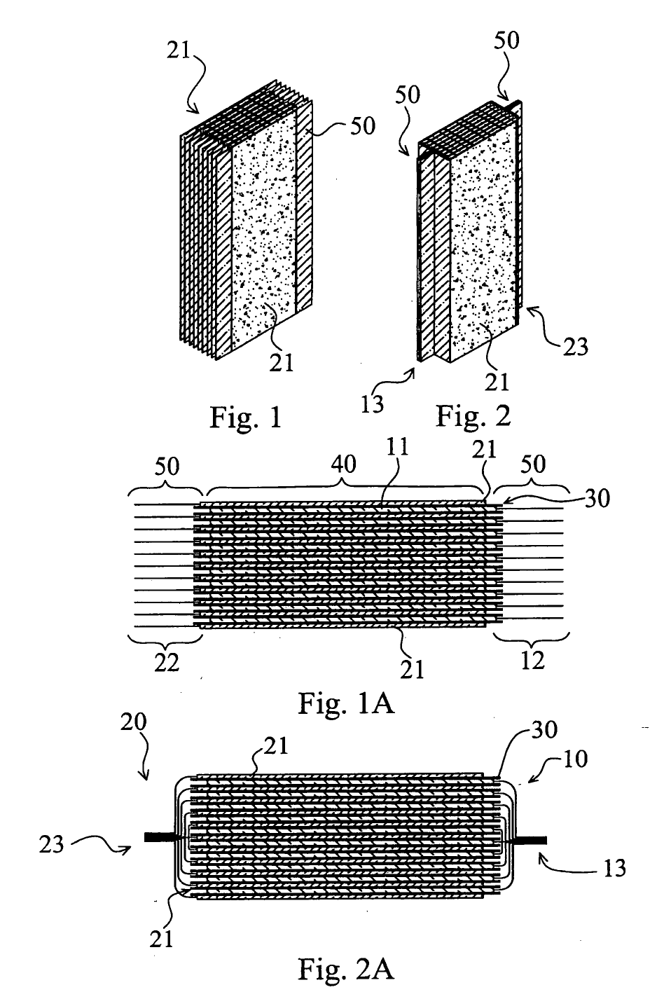

FIG. 1 shows a stack of parallely interposed positive and negative electrode plates with separators interposed between adjacent electrode plates. The electrode plates are divided into a positive electrode group 10 comprising a plurality of positive electrode plates 11 with positive lead portions 12 and a negative electrode group 20 comprising a plurality of negative electrode plates 21 with negative lead portions 22. The positive and negative electrode groups together constitute the electrode group of a prismatic cell. The electrode groups 10, 20 are arranged so that positive electrode plates 11 and negative electrode plates 21 are interleaved with a separator 30 interposed between each pair of positive and negative electrode plates.

Each of the electrode plates includes an active region 40 and a lead region 50. The corresponding active regions of a pair of positive and negative plates are in juxtaposition and react in the presence of an electrolyte to convert chemical energy into electrical energy. The active regions 40 of the electrode plates of a typical prismatic battery cell are substantially rectangular with one of the longer or longitudinal sides juxtaposing the lead portion 50. The lead portion 50 is typically elongated and is of substantially the same length as the longitudinal side of the active region as well as being substantially rectangular. The rectangular active regions of the electrode plates are usually form from a rectangular base material and hence the active region 40 and the lead portion 50 have substantially the same length. Of course, it should be appreciated that while active regions are usually rectangular, it is not strictly necessary so and active regions of shapes other than rectangular can be used without loss of generality.

In a Nickel-Metal-Hydride rechargeable battery, the active regions of the positive electrode plates are made of a nickel-foamed metal coated with nickel hydroxide. The active regions of the negative electrode plates are made of a nickel punched metal sheet coated with negative electrode constituting materials such as a hydrogen-absorbing alloy. The electrode plates are typically very thin to reduce material costs and weight since the electricity generating reaction is surface in nature. The current collectors are usually nickel-plated copper or steel for good thermal and electrical conductivity. For prismatic battery cells in which the electrode plates are connected to the current collectors by electronic beam welding or carbon dioxide laser welding, the current collectors are typically thin nickel-plated plates since the actual welding junction is behind the approaching surface of the welding source. As such current collector plates have a very small cross-sectional area, they are not particularly efficient for thermal or electrical conduction. Where the electrode plates are spot-welded to the current collectors, the welded spots are usually highly resistive and the conductivity of the current collectors may not be sufficiently efficient to dissipate the adverse heat.

In the present invention, the lead portions 50 of the electrode plates are first bundled together. Bundling in the present context including but not limited to the pressing, packing, gathering, welding or fastening of the respective lead portions of the electrode groups. The bundled lead portions may further be maintained in form by soldering, welding or mechanical fastening means such as riveting. Furthermore, before the lead portions are bundled together, the electrode groups are usually already in the interleaving configuration with adjacent electrode plates in a closely packed relationship.

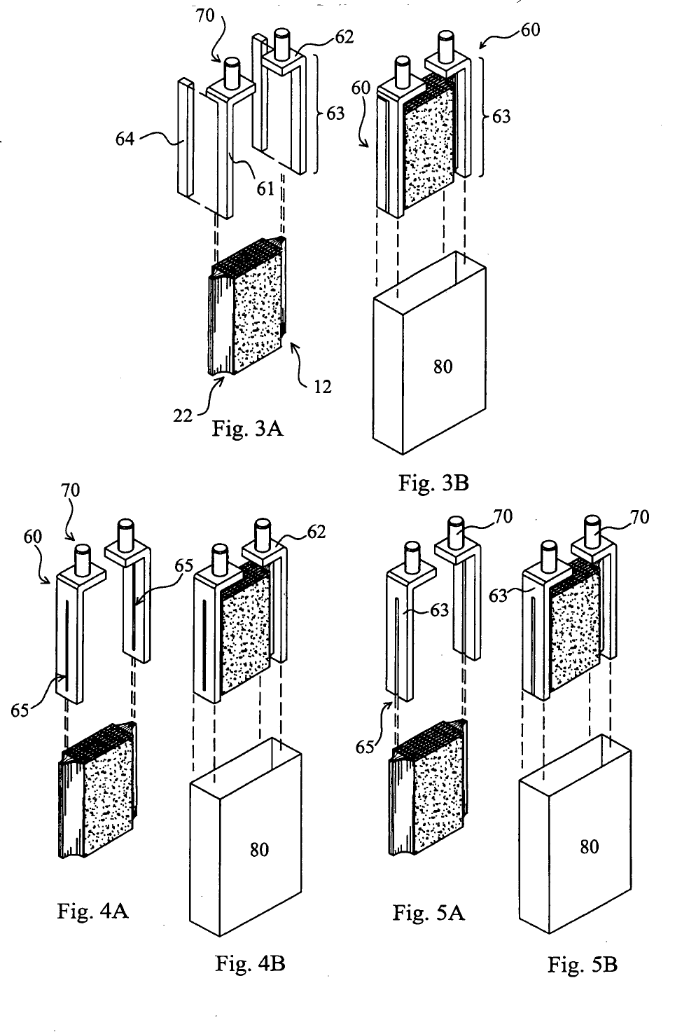

Referring to FIGS. 3A to 5B, bundled electrode groups are assembled with the current collectors and the contact terminals intact. The sub-assembly will then be inserted into a prismatic housing.

Referring to FIGS. 3A and 3B, there is shown a first preferred embodiment of a prismatic battery cell of the present invention. Referring firstly to FIG. 3A, the electrode plates are in the parallelly stacked, interposed, configuration so that electrode plates of the same electrode groups are bundled together along the outer and longer free edges of the lead portions. This bundling can be done, for example by mechanically pressing together of the free longitudinal or longer sides of the lead portions of the electrode plates. The bundling can be further enhanced by welding or soldering of the bundled edges of the electrode plates or by additional mechanical fastening, for example, by riveting. After the electrode groups have been bundled together, the electrode groups are attached to the current collector.

The current collector 60 of this preferred embodiment comprises two parts. The first part 61 comprises a main conductor member 61 having a generally inverted L-shape with a substantially cylindrical contact terminal 70 extending from the top surface 62 of the shorter bent end of the inverted L-shaped main conductor member. A portion of the longer side 63 of the main conductor member is removed substantially longitudinally along the entire length of the longer side 63 of the main conductor member so that the longer side of the inverted L-shaped main conductor body also has an inverted-L shaped when viewed orthogonally from the plane of the longer side.

The second part 64 includes a substantially prismatic member which complements the removed portion of the longer side of the main conductor member so that when the first 61 and the second 64 parts are soldered or welded together with the bundled portion of the electrode group sandwiched between the two parts, the longer side of the current collector is substantially rectangular. The sub-assembly comprising the interleaved and bundled electrode groups 13, 23 and the current collectors 60 are mounted together. After mounting, the bundled electrode groups are sandwiched between the two current collectors, namely, the positive and negative current collectors, with the inside surfaces of the current collectors opposite each other.

Turning next to the mounting of the sub-assembly comprising the bundled electrode groups and the current collectors, the bundled longer or lateral sides of the electrode groups are first longitudinally aligned with the longer side of the main conductor member of the current collector. The second part 64 of the current collector 60 is then put in place, for example, with the assistance of a jig so that the longitudinally bundled portions of the electrode groups are held tightly between the gap formed between the first part 61 and the second part 64 of the current collector. The bundled portions are then welded or soldered substantially along its entire length to the current collector so that both lateral sides of the bundled portions of the electrodes are respectively soldered to the first and the second parts of the current collector.

With electrical connection substantially made along the entire length of the bundled portion and with electrical contacts made between the two sides of the current collector approaching the bundled portion, substantial by enhanced electrical and thermal conductivity can be provided.

Furthermore, as welding or soldering is made along the front or outer surfaces of the current collectors with the electrode plates bundled together, welding can be better controlled and premature melting of the electrode plates will not be a major concern.

Furthermore, as the bundled portions are sandwiched between the gap formed between the first and the second part of the current collector during welding and welding also takes place at the front or outer surfaces of the current collector, the main conductor member can be of a sufficient thickness to improve enhanced thermal and electrical conductivity, thereby reducing both the internal resistance as well as providing better heat dissipation path through the current collectors and then to the contact terminals to the outside. After the sub-assembly has been formed, the sub-assembly is inserted into a housing 80 filled with an alkaline electrode and the housing can be sealed for sealed operation. It will be noted that the housing is substantially prismatic so that the sealed battery cell also has a generally prismatic shape.

Referring to FIGS. 4A and 4B, there is shown a second preferred embodiment of the present invention. The construction of prismatic cells of this second preferred embodiment are substantially identical to that of the first preferred embodiment as shown in FIGS. 3A and 3B. In the description below, the same reference numerals will be used to the extent appropriate.

Referring to FIGS. 4A and 4B, instead of having the current connector with a first part and a second part, the current collector is a substantially inverted L-shaped main member with a through channel extending longitudinally along the main side of the current collector. The longitudinal through channel 65 is adapted for closely receiving the bundled portion so that bundled portion of the respective electrode groups will be closely received along the through channel. After the bundled lead portions of the electrode groups has been fitted into the longitudinal through channel, the bundled lead portions of the electrode groups can be welded or soldered onto the main side of the current collectors. As the bundled lead portions are received along the through channels, welding can be done from the outer surface of the current collector, thereby effecting better and more economical welding.

Referring to FIGS. 5A and 5B showing a third preferred embodiment of the present invention, the current collector of this preferred embodiment is substantially identical to that of the second preferred embodiment, although the through channel extends until the lower free end of the in body of the current collector so that the bundled portions of the electrode groups can slide into position for soldering along the longitudinally extending through channel from the free end of the current collector.

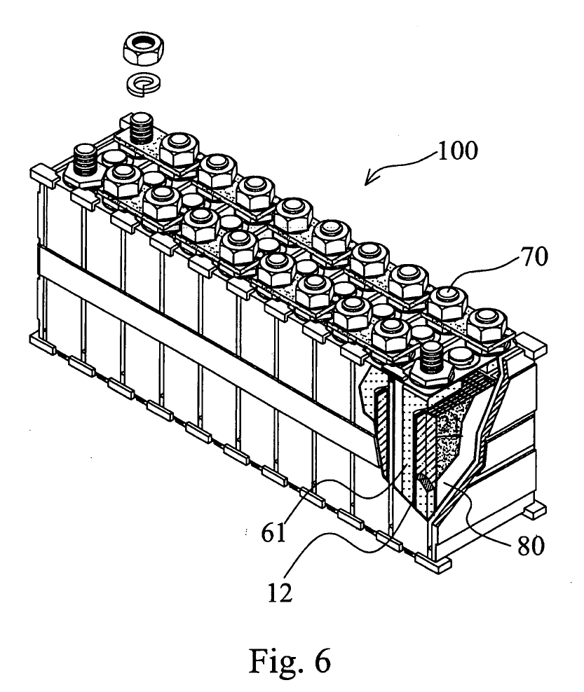

Referring to FIG. 6, there is shown a plurality of prismatic cells of any of the preferred embodiments integrally bound in a substantially parallel manner to form a prismatic battery illustrating an example of the application of the present invention.

While the present invention has been explained by reference to the preferred embodiments described above, it will be appreciated that the embodiments are illustrated as examples to assist understanding of the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention.

Furthermore, while the present invention has been explained by reference to NiMH battery, it should be appreciated that the invention can apply, whether with or without modification, to other prismatic batteries without loss of generality.

1. A prismatic battery cell including a positive electrode group and a negative electrode group which are connected respectively to a positive current collector and a negative current collector, each side positive electrode group and said negative electrode group respectively including a plurality of positive and negative electrode plates, said positive and negative electrode groups are assembled so that positive and negative electrode plates are alternately stacked with separators interposed between adjacent positive and negative electrodes, wherein the electrode plates of an electrode group being bundled together and welded to the corresponding current collector, the welding being generally along the bundled portion of the electrode group and at least on the surface of said current collector away from said electrode group.

2. A battery according to claim 1, wherein said current collector including an elongated through channel in which the bundled portion of said electrode group, is received, said electrode group being welded to said current collector substantially along said channel.

3. A battery according to claim 2, wherein said channel extending substantially parallel to the longer side of said electrode plates.

4. A battery according to claim 2, wherein said through channel being near the center of said current collector.

5. A battery according to claim 2, wherein said channel extending longitudinally along the length of said current collector.

6. A battery according to claim 2, wherein the width of said current collector being comparable or larger than the stacked thickness of said electrode groups.

7. A battery according to claim 1, wherein said current collector including a plate-like member, the width of said plate-like member being substantially orthogonal to said electrode plates so that the welded portion has a generally T-shaped cross-section.

8. A battery according to claim 2, wherein the thickness of said current collector exceeds the thickness suitable for electronic beam welding or carbon dioxide laser welding.

9. A battery according to claim 2, wherein said welding being by arc-welding including TIG welding.

10. A battery according to claim 2, wherein said battery cell being a rechargeable nickel metal battery cell with an alkaline electrolyte.

11. A battery according to claim 1, wherein the bundled portion of said electrode group being sandwiched between said current collector.

12. A battery according to claim 1, wherein said battery cell being sealed inside a plastic housing and said current collector being connected to contact terminals exposed outside said plastic housing, the width of the cross-section of said contact terminal being comparable to the width of the stacked electrode plates.

13. A battery including battery cells as claimed in claim 1.
